(19) United States
(12) Patent Application Publication
(10) Pub. No.: US 2011/0131437 A1
(43) Pub. Date: Jun. 2, 2011

(54) INFORMATION PROCESSING DEVICE

(75) Inventor: Yasuhito Shimazaki, Ome-shi (JP)

(73) Assignee: KABUSHIKI KAISHA TOSHIBA, Tokyo (JP)

(21) Appl. No.: 12/956,384

(22) Filed: Nov. 30, 2010

(30) Foreign Application Priority Data
Nov. 30, 2009 (JP) 2009-272697

(51) Int. Cl. G06F 1/32

(52) U.S. Cl. 713/323

(57) ABSTRACT

According to one embodiment, an information processing apparatus includes a controller, a wakeup controller, a power source, an input controller, and a switch. The controller configured to perform communications with an external device. The wakeup controller configured to wake up a system in accordance with a request from the external device. The power source configured to generate a driving power to drive the controller and to supply the driving power to the controller. An input controller configured to output a signal according to an operation of an input device. The switch configured to instruct the power source to switch between supply and non-supply of the driving power when a predetermined signal is output from the input controller in a state in which the system is not woken up.

### CROSS-REFERENCE TO RELATED APPLICATIONS

This application is based upon and claims the benefit of priority from Japanese Patent Application No. 2009-272697, filed Nov. 30, 2009; the entire contents of which are incorporated herein by reference.

### FIELD

Embodiments described herein relate generally to an information processing device in which a system is woken up according to a request from an external device.

### BACKGROUND

Computers are provided with a function (LAN, USB, HDMI-CEC, and the like) that allows the computer to be woken up from a power-off state according to a request from an external device (see Jpn. Pat. KOKAI Publication No. 2001-092565, for example).

In order to allow a computer to be woken up according to a request from an external device, a driving power needs to be supplied to a controller that performs communications with the external device even when the computer is in a power-off state, which results in increase in standby power. In a BIOS, for example, there is an enable/disable setting for setting whether to allow a computer to be woken up according to a request from an external device. In order to make such a setting, the computer needs to be woken up and then the setting needs to be changed.

### BRIEF DESCRIPTION OF THE DRAWINGS

A general architecture that implements various features of embodiments will now be described with reference to the drawings. The drawings and the associated descriptions are provided to illustrate the embodiments and not to limit the scope of the invention.

FIG. 1 is a perspective view illustrating an outer view of an information processing device according to an embodiment.

FIG. 2 is a block diagram illustrating an example system configuration of an information processing device such as that shown in FIG. 1.

FIG. 3 is a view illustrating example keys and input rules for switching between supply and non-supply of a driving power to an HDMI-CEC controller, and an LED display state when the switching is made.

FIG. 4 is a view illustrating example keys and input rules for switching between supply and non-supply of the driving power to a LAN controller, and an LED display state when the switching is made.

FIG. 5 is a view illustrating example keys and input rules for switching between supply and non-supply of the driving power to a USB controller, and an LED display state when the switching is made.

### DETAILED DESCRIPTION

Various embodiments will be described hereinafter with reference to the accompanying drawings.

In general, according to one embodiment, an information processing apparatus includes a controller, an wakeup module, a power source, an input controller, and an instruction module. The controller configured to perform communications with an external device. The wakeup module configured to wake up a system in accordance with a request from the external device. The power source configured to generate a driving power to drive the controller and to supply the driving power to the controller. An input controller configured to output a signal according to an operation of an input device. The instruction module configured to instruct the power source to switch between supply and non-supply of the driving power when a predetermined signal is output from the input controller in a state in which the system is not woken up.

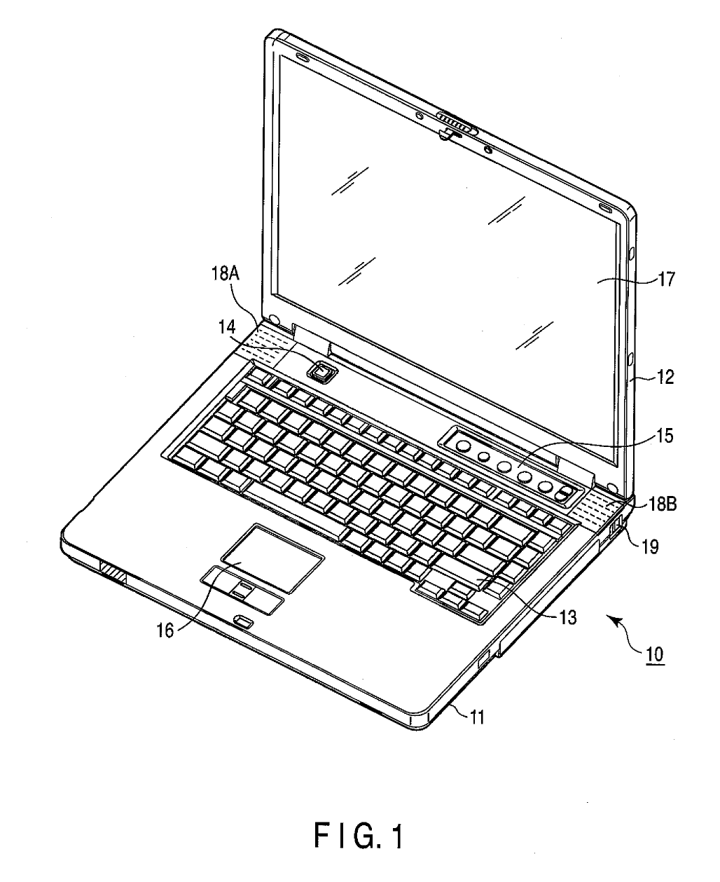

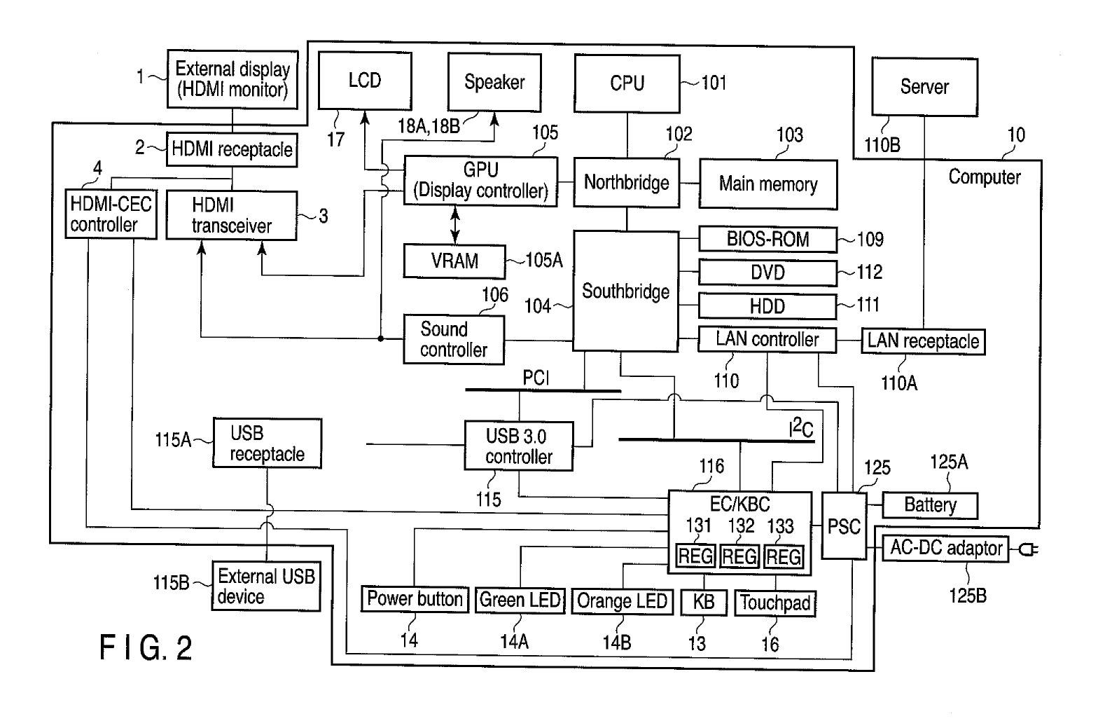

A configuration of a playback device according to an embodiment of the present invention will be described with reference to FIGS. 1 and 2. The playback device of the present embodiment is embodied as a notebook computer 10, which functions as an information processing device, for example.

The personal computer 10 is capable of recording and playing back video content data (audiovisual content data), such as broadcast program data and video data input from an external device. That is, the personal computer 10 is provided with a television (TV) function for allowing a user to view and record broadcast program data broadcast by a television broadcast signal. The TV function is embodied by a TV application program installed in advance in the personal computer 10, for example. Further, the TV function also includes a function of recording video data input from an external AV device, and a function of playing back recorded video data and recorded broadcast program data.

FIG. 1 is a perspective view of the computer 10 in a state in which a display unit is open. The computer 10 comprises a computer main body 11 and a display unit 12. The display unit 12 includes a display device formed of a thin-film transistor liquid crystal display (TFT-LCD) 17 installed therein.

The display unit 12 is rotatably attached to the computer main body 11 between an open position in which an upper surface of the computer main body 11 is exposed and a closed position in which the upper surface of the computer main body 11 is covered. The computer main body 11 has a thin box-shaped housing, and includes a keyboard 13, a power button 14 for powering on/off the computer 10, an input operation panel 15, a touchpad 16, speakers 18A, 18B, and the like, which are arranged on an upper surface of the computer 11. Inside the power button 14, a green LED and an orange LED are embedded as light-emitting elements indicating the activation states of the system. A portion of the top surface of the power button 14 is formed of a translucent member, and allows light emitted from the green LED or the orange LED to be visible.

The input operation panel 15 is an input device for inputting an event corresponding to a pressed button, and includes a plurality of buttons for activating a plurality of functions.

On a back surface of the computer main body 11, for example, a receptacle compliant with the High-Definition

Multimedia Interface (HDMI) standard is provided for connection with an external display. The receptacle for connection with an external display is used so as to output video data (moving image data) included in video content data, such as broadcast program data, to an external display.

Further, on the back surface of the computer main body 11, for example, a network receptacle compliant with the 100BASE-T standard is provided. A plug of a twisted pair cable for network communications is inserted into the network receptacle, and network communications are performed with other computers. Further, on the back surface of the computer main body 11, for example, a receptacle for connection with a USB device compliant with the universal serial bus (USB) is provided. A plug of a USB cable is inserted into the network receptacle, and USB communications are performed with a USB device.

Next, the system configuration of the computer 10 will be described with reference to FIG. 2.

As shown in FIG. 2, the computer 10 comprises a CPU 101, a Northbridge 102, a main memory 103, a Southbridge 104, a graphics processing unit (GPU) 105, a video memory (VRAM) 105A, a sound controller 106, a BIOS-ROM 109, an HDMI transceiver 3, an HDMI-CEC controller 4, a USB 3.0 controller 115, a LAN controller 110, a hard disc drive (HDD) 111, a DVD drive 112, an embedded controller/keyboard controller IC (EC/KBC) 116, and the like.

The CPU 101 is a processor configured to control the operation of the computer 10, and executes an operating system (OS) 201 and various application programs, such as a DVD application program 202, which are loaded from the hard disc drive (HDD) 111 to the main memory 103. The DVD application program 202 is software for playing back a DVD loaded in the DVD drive 112. Further, the CPU 101 also executes a Basic Input/Output System (BIOS) stored in the BIOS-ROM 109. The BIOS is a program for hardware control.

The Northbridge 102 is a bridge device for connecting the local bus of the CPU 101 and the Southbridge 104. The Northbridge 102 also includes a memory controller integrated therein and configured to control access of the main memory 103. Further, the Northbridge 102 is also provided with a function of executing communications with a GPU 105 via a serial bus compliant with the PCI EXPRESS standard, for example.

The GPU 105 is a display controller configured to control the LCD 17 used as a display monitor of the computer 10. A display signal generated by the GPU 105 is transmitted to the LCD 17. Further, the GPU 105 is capable of transmitting a digital video signal to an external display device 1 via the HDMI transceiver 3 and the HDMI receptacle 2.

The HDMI receptacle 2 is a receptacle for connection with an external display, as described above. The HDMI receptacle 2 is capable of transmitting a non-compressed digital video signal and a digital audio signal to the external display device (sync device) 1 using one cable. The HDMI transceiver 3 is an interface configured to transmit digital video/audio signals to the external display device 1 called an HDMI monitor via the HDMI receptacle 2.

Further, the HDMI receptacle 2 is capable of transmitting a command for controlling the operation of the external display device 1 defined by the HDMI standard or a vendor to the external display device 1, and receiving a command for controlling the operation of the computer 10 defined by the HDMI standard or the vendor from the external display device 1. The HDMI-CEC controller 4 is a controller configured to transmit a command for controlling the external display device 1. Further, the HDMI-CEC controller 4 is a controller for controlling the computer 10 according to a command transmitted from the external display device 1. Commands transmitted from the external display device 1 include a [Power] command for waking up the computer 10. The HDMI-CEC controller 4 transmits a wakeup signal to the EC/KBC 116 upon receipt of the [Power] command. The HDMI transceiver 3 and the HDMI-CEC controller 4 may be provided as one semiconductor chip.

The LAN receptacle 110A is the above-described network receptacle. The LAN controller 110 is a communication device configured to perform communications with a sever 110B connected to a network, and performing communications with an external network, such as the Internet. Further, the LAN controller transmits a wakeup signal to the EC/KBC 116 upon receipt of a magic packet from the server 110B.

The USB receptacle 115A is the above-described receptacle for connection with a USB device. The USB 3.0 controller 115 is a communication device configured to perform communications with an external USB device 115B compliant with the USB 3.0 standard, such as a hard disc drive. Further, the USB 3.0 controller 115 transmits a wakeup signal to the EC/KBC 116 upon receipt of a command for instructing the computer 10 to wake up from the external USB device 115B.

The Southbridge 104 controls devices on a Low Pin Count (LPC) bus and a Peripheral Component Interconnect (PCI) bus. Further, the Southbridge 104 includes an Integrated Device Electronics (IDE) controller configured to control the hard disc drive (HDD) 111 and the DVD drive 112. Moreover, the Southbridge 104 is provided with a function of executing communications with the sound controller 106.

The sound controller 106 is a sound source device, and outputs audio data to be played back to the speakers 18A, 18B or the HDMI transceiver 3.

The embedded controller/keyboard controller IC (EC/KBC) 116 is a single-chip microcomputer, in which an embedded controller for power management and a keyboard controller configured to control the keyboard (KB) 13 and the touchpad 16 are integrated.

The keyboard controller of the EC/KBC detects which operation key of the keyboard 13 is pressed down by a key scan operation of judging on/off states of the switch, and outputs a signal according to the detected operation key.

Further, the EC/KBC 116 is designed to manage the power source state of the computer 10 in cooperation with a power source controller (PSC) 125. The operation power source is kept being supplied to the EC/KBC 116 and the power source controller (PSC) 125, even after the computer 10 is powered off and is shifted to a sleep state or a stopped state. The EC/KBC 116 is provided with a function of controlling the power source controller (PSC) 125 in response to detection of generation of a power source on/off cause, for example.

Further, the EC/KBC 116 is provided with a function of monitoring a wakeup signal from the HDMI-CEC controller 4, the LAN controller 110, and the USB 3.0 controller 115. The EC/KBC 116 instructs the power source controller 125A to wake up a system upon receipt of a wakeup signal.

When an external power source is supplied via the AC/DC adaptor 125B, the power source controller 125 generates a system power source (driving power) to be supplied to components of the computer 10, such as the HDMI-CEC controller 4, the LAN controller 110, and the USB 3.0 controller 115, using the external power source supplied from the AC/DC adaptor 125B. Further, when an external power source is not supplied via the AC/DC adaptor 125B, a system power source (driving power) to be supplied to components of the computer 10, such as the HDMI-CEC controller 4, the LAN controller 110, and the USB 3.0 controller 115, is generated using the battery 125A, and supplied to each component. Further, the power source controller 125 is capable of switching between supply and non-supply of the system power source to each component independently according to an instruction from the EC/KBC 116.

When a set key of a keyboard is operated according to set rules in a state in which the system is not woken up, the

EC/KBC 116 gives an instruction for switching between supply and non-supply of the driving power to one of the HDMI-CEC controller 4, the LAN controller 110, and the USB 3.0 controller 115 to the power source controller 125.

The keyboard controller in the EC/KBC 116 transmits a signal corresponding to the operated key to an embedded controller in the EC/KBC 116 when a keyboard is operated in a power-off state. When the received signal corresponds to the set key and compliant with the set rules, the embedded controller gives an instruction for switching between supply and non-supply of the driving power to one of the HDMI-CEC controller 4, the LAN controller 110, and the USB 3.0 controller 115 to the power source controller 125.

In register 131, the value indicating the supply/non-supply state of the driving power to each of the HDMI-CEC controller 4, the LAN controller 110, and the USB 3.0 controller 115 is written. The value in the case where the driving power is supplied is “1 (Enable)” and the value in the case where the driving power is not supplied is “0 (Disable)”. For example, the default value written in register 131 is “111”. The first digit from the left indicates supply/non-supply state of the driving power to the HDMI-CEC controller 4, the second digit from the left indicates the supply/non-supply state of the driving power to the LAN controller 110, and the third digit from the left indicates the supply/non-supply state of the driving power to the USB 3.0 controller 115. When the EC/KBC 116 gives an instruction for switching between supply and non-supply of the driving power to one of the HDMI-CEC controller 4, the LAN controller 110, and the USB 3.0 controller 115, the value stored in register 131 is updated according to the instruction.

Further, register 132 stores values indicating whether to invalidate the supply/non-supply switching when the power source controller 125 generates the system power source using the power supplied from the AC/DC adaptor 125B. The EC/KBC 116 generates the system power source using the power supplied from the AC/DC adaptor 125B, and does not issue an instruction for switching between supply and non-supply of the driving power even when the set key is operated in the case where the value of the register is indicated as being invalid. The EC/KBC 116 generates a system power source using the power supplied from the AC/DC adaptor 125B, and issues an instruction for switching between supply and non-supply of the driving power when the set key is operated in the case where the value of the register is indicated as being valid.

Further, a value indicating whether to reset the value of register 131 and make the value “111” or not at the time of system wakeup is written in register 133. Referring to the value of register 133 at the time of wakeup of the system, the EC/KBC 116 makes the value of register 131 “111” and reset the value when the value of register 131 is indicated as being reset.

The values of registers 132, 133 may be changed by a user by setting from the BIOS, for example.

The embedded controller in the EC/KBC 116 notifies the user of the supply/non-supply state of the driving signal after the switching by causing the green LED 14A and the orange LED 14B to emit light after the switching instruction is given.

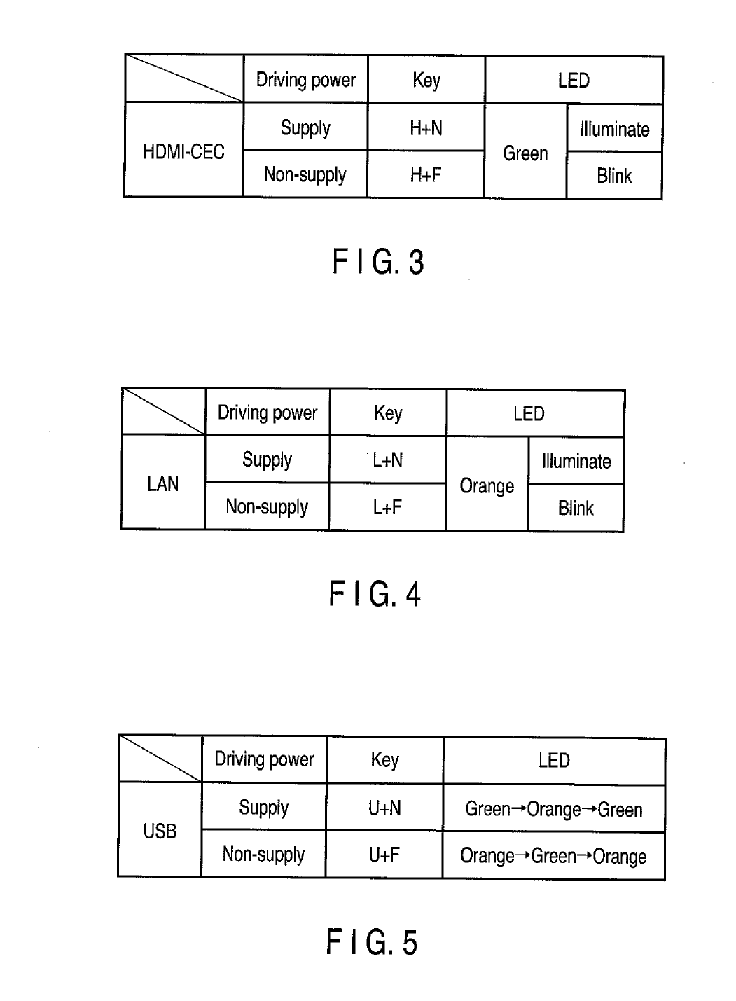

Next, the keys and input rules for switching between supply and non-supply of the driving power to the HDMI-CEC controller and the LED display state when the switching is made in the case where the system is not woken up will be described with reference to FIG. 3.

As shown in FIG. 3, the driving power is supplied from the power source controller to the HDMI-CEC controller when the “H” key and the “N” key of the keyboard are operated. When the driving power is supplied to the HDMI-CEC controller, the green LED illuminates. Further, when the “H” key and the “F” key of the keyboard are operated, the driving power is not supplied to the HDMI-CEC controller from the power source controller. When the driving power is not supplied to the HDMI-CEC controller, the green LED blinks.

The keys for switching between supply and non-supply of the driving power to the LAN controller and the LED display state when the switching is made in the case where the system is not woken up will be described with reference to FIG. 4.

As shown in FIG. 4, the driving power is supplied to the LAN controller from the power source controller by operating the “L” key and the “N” key of the keyboard. When the driving power is supplied to the LAN controller, the orange LED illuminates. Further, when the “L” key and the “F” key of the keyboard are operated, the driving power will not be supplied to the LAN controller from the power source controller. When the driving power is not supplied to the LAN controller, the orange

LED blinks.

The keys for switching supply and non-supply of the driving power to the USB 3.0 controller and the LED display state when the switching is made in the case where the operating system is no woken up will be described below with reference to FIG. 5.

As shown in FIG. 5, when the “U” key and the “N” key of the keyboard are operated, the driving power is supplied to the USB 3.0 controller from the power source controller. When the driving power is supplied to the USB 3.0 controller, the LEDs illuminate in the order of the green LED, the orange LED, and the green LED. Further, when the “U” key and the “F” key of the keyboard are operated, the driving power will not be supplied to the USB 3.0 controller from the power source controller. When the driving power is not supplied to the USB 3.0 controller, the LEDs illuminate in the order of the orange LED, the green LED, and the orange LED.

As described above, it is possible to switch between supply and non-supply of the driving power in the controller for performing communications with an external device even when the system is not woken up.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a communication controller configured to perform communications with an external device;
a wakeup controller configured to wake up a system in accordance with a request from the external device;
a power source configured to generate a driving power to drive the communication controller and to supply the driving power to the communication controller;
an input controller configured to output a signal according to an operation of an input device; and
a switch configured to instruct the power source to switch between supply and non-supply of the driving power when a predetermined signal is output from the input controller in a state in which the system is not woken up.

2. The information processing apparatus of claim 1, wherein the communication controller is configured to perform one of an HDMI-CEC communication, a USB communication, and a network communication.

3. The information processing apparatus of claim 1, further comprising an indicator configured to indicate a switching between the supply and the non-supply of the driving power when the switch has instructed the switching.

4. The information processing apparatus of claim 3, wherein the indicator is configured to produce a first indication when the switch instructs to switch to the non-supply from the supply, and to produce a second indication when the switch instructs to switch to the supply from the non-supply, wherein the first indication and the second indication are distinguished from each other.

5. The information processing apparatus of claim 3, wherein the indicator comprises a light-emitting device.

6. The information processing apparatus of claim 1, wherein the power source is configured to generate the driving power from a first direct-current power supplied from an AC/DC adaptor or a second direct-current power supplied from a battery.

7. The information processing apparatus of claim 6, wherein the switch does not instruct the switching between the supply and the non-supply when the predetermined signal is output from the input controller in a state in which the power source generates the driving power from the first direct-current power.

8. The information processing apparatus of claim 1, wherein the switch is configured to instruct the power source to switch to the supply from the non-supply before the system is woken up.

9. The information processing apparatus of claim 1, wherein the input device comprises a keyboard.
